(19) United States
(12) Patent Application Publication
(10) Pub. No.: US 2005/0017908 A1
(43) Pub. Date: Jan. 27, 2005

(54) Antenna device

(76) Inventor: Atle Saegrov, Trondheim (NO)

Correspondence Address: CHRISTIAN D. ABEL, ONSAGERS AS, POSTBOKS 6963 ST. OLAVS PLASS, NORWAY, N-0130, NO

(21) Appl. No.: 10/501,348

(22) PCT Filed: Jan. 22, 2003
(86) PCT No.: PCT/NO03/00021

(30) Foreign Application Priority Data
Jan. 23, 2002 (NO) 2002 0357

(51) Int. Cl. H01Q 1/24

(52) U.S. Cl. 343/702; 343/906

(57) ABSTRACT

The invention relates to an antenna device for use with a radio transmitter (122) mounted in an electrical installation cabinet (100) such as a fuse box, where at least one electrical supply line (130) is passed through an opening (140) in the installation cabinet (100). The antenna device comprises a signal connection of the radio transmitter's antenna output (150) to a section of the supply line inside the installation cabinet (100). The result of this is that the supply line (130) is employed as a travelling wave antenna for the radio transmitter (122). The invention further relates to a remote reading device in which the device is included, a method for providing an antenna for a radio transmitter in an installation cabinet and an application of a supply line that is passed into or out of the installation cabinet.

### FIELD OF THE INVENTION

The present invention relates to radio communication, especially radio communication employed in the field of remote reading of energy consumption meters.

In more specific terms the invention relates to an antenna device for use with a radio transmitter mounted in an electrical installation cabinet such as a fuse box.

The invention also relates to a remote reading device for remote reading of an energy consumption meter to be mounted in such an installation cabinet.

The invention further relates to a method for providing an antenna for a radio transmitter mounted in such an electrical installation cabinet.

The invention finally relates to an application of an electrical supply line passed into or out of an electrical installation cabinet such as a fuse box.

### BACKGROUND ART

Energy consumption meters, such as supply meters for electrical energy, water or gas were formerly read manually. In recent times a number of remote reading solutions have been offered for simplifying and automating the reading of such supply meters, where, for example, a radio-based remote reading unit is provided which is arranged to read the supply meter and transmit to a remotely located receiver a radio signal, which identifies the supply meter as well as providing measured data for the reading.

Energy consumption meters, particularly for electrical energy, are often installed within an electrically earthed metal cabinet, e.g. a fuse box. When a radio-based reading unit is placed inside such a cabinet, a problem is to provide a suitable antenna for the reading unit.

A number of requirements have to be met by this kind of remote reading equipment. These include the need for the equipment to be inexpensive to produce, for it not to occupy unnecessary space and to be simple and inexpensive to install.

U.S. Pat. No. 6,262,685 discloses a radio-based remote reading unit for mounting on existing supply meters. Here the remote reading unit is provided with a passive radiation element capacitively coupled to a transceiver. The radiation element forms a resonant antenna, which acts as a conventional half-wave dipole. A solution of this kind will result in altered radiation characteristics for the antenna and difficult radio communication conditions if the remote reading unit is located in a partially tight, earthed installation cabinet such as a metal fuse box.

It is also known in the prior art to use existing supply lines to a meter reader for transmitting signals associated with the reading. Thus U.S. Pat. No. 4,350,980 discloses a solution where an electrical signal with a frequency typically of 100 kHz is superposed inductively on such a supply line by means of a transformer. Pulses are then derived in a signal decoupling unit with a corresponding transformer inductively coupled to the supply line. This solution is based on transmission by means of electromagnetic propagation in TEM mode (Transversal Electromagnetic Mode), with the line connection as transmission line. The solution cannot be seen to be suitable for using the power supply line as an antenna for wireless radio transmission over long distances.

From other technical contexts it is previously known to use a power supply cable as antenna element for a radio transmitter. U.S. Pat. No. 4,032,723 discloses a system for wireless telephony employing a doublet antenna, where a conductor in the power supply network is used as a first antenna element, while a separate wire antenna is used as a second antenna element. The necessity of a separate wire antenna apparently does not make this solution suitable for use with a radio transmitter located in a metal cabinet.

### SUMMARY OF THE INVENTION

An object of the present invention is to provide an antenna device, a remote reading device, a method and an application as mentioned in the introduction, which overcome at least some of the disadvantages of the prior art solutions.

A second object of the invention is to provide an antenna device, a remote reading device, a method and an application as mentioned in the introduction, which overcome at least some of the disadvantages of the prior art solutions.

A second object of the invention is to provide an antenna device, a remote reading device, a method and an application as mentioned in the introduction, which provide a high level of reliability, good broadband characteristics, inexpensive production and installation costs, utilisation of already existing equipment and minimal space requirements.

The above-mentioned objects are achieved by means of an antenna device, a remote reading device, a method and an application as set forth the appended, independent patent claims.

Further advantageous features will be apparent from the dependent claims.

By means of the invention an antenna solution is obtained based on the travelling wave principle, thus making the solution extremely broadband, and suitable for transmission on frequency bands over several decades. The travelling wave principle involves the use of the supply line network as a broadband coupling structure, and not as a resonant antenna element. This results in substantial advantages compared with ordinary resonant antenna structures, where the bandwidth is typically restricted to approximately 10-20% of the antenna's centre frequency.

### BRIEF DESCRIPTION OF THE DRAWINGS

The invention will now be described in greater detail in the form of embodiments with reference to the attached schematic drawings, in which

FIG. 1 illustrates system components in an installation cabinet wherein an antenna device according to a first embodiment of the invention is included,

FIG. 2 illustrates in greater detail an antenna device according to the first embodiment of the invention,

FIG. 3 illustrates system components in an installation cabinet wherein an antenna device according to a second embodiment of the invention is included, and

FIG. 4 illustrates system components in an installation cabinet wherein an antenna device according to a third embodiment of the invention is included, and

FIGS. 5a-5b illustrate two alternative detail solutions for matching to the frequency range 60 MHz-90 MHz.

### DETAILED DESCRIPTION OF PREFERRED EMBODIMENTS

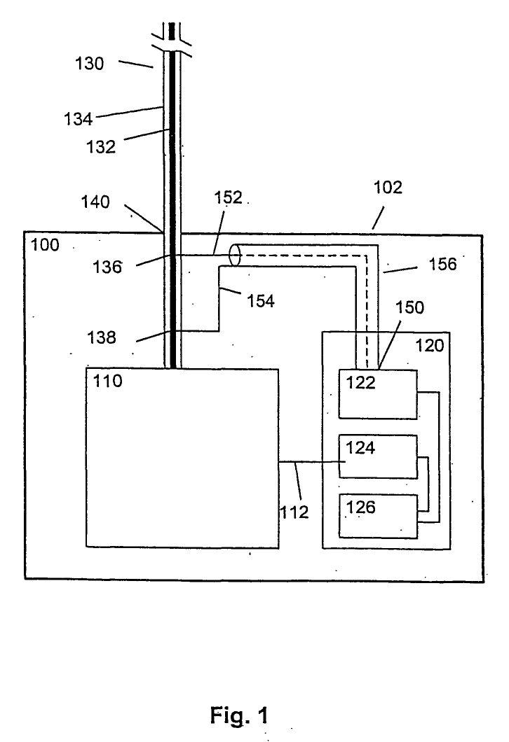

FIG. 1 illustrates system components in an installation cabinet in which is included an antenna device according to a first embodiment of the invention.

An installation cabinet 100, such as a fuse box, is composed of a metallic housing, where a number of alternating current supply lines are passed in and out through openings in the cabinet. A line of this kind is indicated by 130. The line 130 is schematically indicated as a single conductor with a conducting core 132 surrounded by an insulation layer 134. In practice the line may be composed of a phase conductor in a multi-conductor cable, such as a cable with two phase conductors and an earth conductor.

Inside the cabinet 100 the line 130 is passed inter alia to a supply meter 110, which may, e.g., be of a type which measures accumulated energy consumption based on the current supplied through the supply line, and which displays these data as a series of numbers.

The supply meter is provided with a remote reading device 120. This comprises a reading unit 124, which normally comprises an optical sensor device for optical reading of a series of numbers on the supply meter 110. The reading unit is connected to a control unit 126, which is arranged to both control the reading unit and to receive data therefrom.

The control unit 126 is further connected to a radio transmitter 122, preferably in the form of a radio transceiver circuit, which has both a transmitter part and a receiver part. The control unit is arranged to supply data to the transmitter part in such a manner that these data are transmitted with a suitable encoding and modulation on an antenna output 150. The transceiver circuit 122 comprises an antenna division circuit, which enables the receiver part to receive radio signals on the antenna that is connected to the antenna output 150.

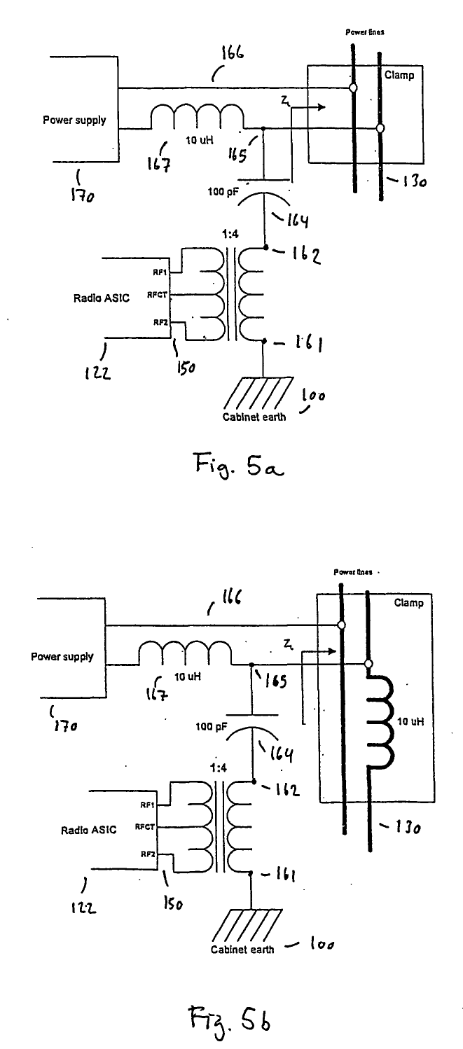

The transceiver circuit 122 may be adapted for use with standardised communication systems such as GSM, GPRS, WLAN or Bluetooth. In an embodiment the transceiver circuit is arranged to operate in the frequency range 900 MHz, or possibly higher, such as 1800 MHz. By means of matching, which is discussed under the description of FIGS. 5a-b, the antenna device is arranged for use with a transceiver circuit operating in a lower frequency range, typically 60 MHz-90 MHz.

The antenna output 150 is connected to the antenna device by means of a coaxial cable 156, or possibly a twisted pair. The cable or the pair has a first 152 and a second 154 conductor.

The antenna device comprises a signal connection of the antenna output 150 to a section of the supply line inside the installation cabinet 100. The result is thereby achieved that the supply line 130 is employed as a travelling wave antenna for the radio transceiver 122.

A simple, inexpensive and reliable antenna function is thereby provided. An already existing line that is passed into or out of the cabinet is employed for the antenna function.

In the embodiment in FIG. 1 the signal connection of the antenna output 150 to the supply line 130 is a galvanic connection. This is achieved by the antenna device comprising contact devices for connecting the first conductor 152 to a first point 136 on the supply line, and the second conductor 154 to a second point 138 on the supply line.

Alternatively, this embodiment may be modified by the second conductor 154 being galvanically or capacitively connected to the installation cabinet 100 instead of to the second point 138 on the supply line.

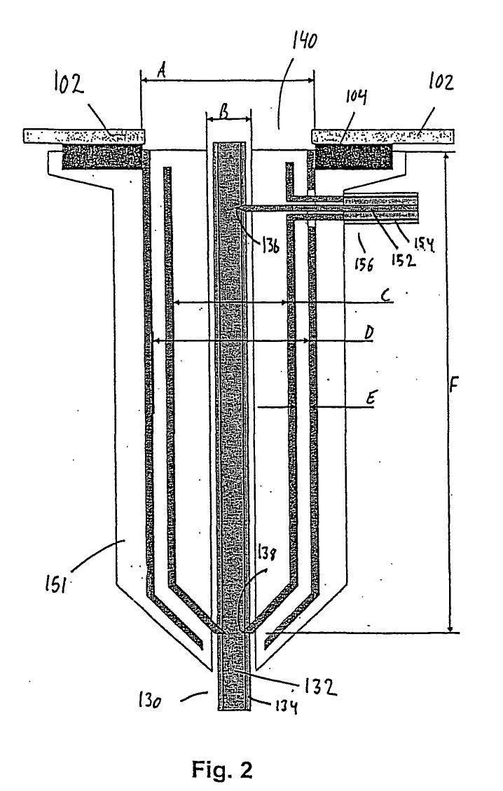

FIG. 2 illustrates in greater detail an antenna device according to the above, first embodiment of the invention.

In this case the antenna device is in the form of a cable terminal, arranged to enclose the supply line. 130. The contact devices comprise metallic contacts 136, 138 designed to be pressed through the insulation sheath 134 enveloping the electrical conductor 132 in the supply line 130, in order to thereby come into contact with the conductor 132. The cable terminal is in the form of a two-part, compressible, injection-moulded plastic component 151 into which the metal contacts 136, 138 are imbedded. The cable terminal is provided with a fastening device 104, for example a permanent magnet, at the end portion that abuts against the inside of the wall 102 of the installation cabinet 100. The magnet may be in the form of a ring surrounding an opening, which when mounted corresponds to the opening 140 in the wall 102 of the installation cabinet 100.

In a practical, advantageous embodiment the cable terminal in FIG. 2 has the following dimensions: A=15 mm, B=3 mm, C=10 mm, D=12 mm, E=1 mm, F=40 mm.

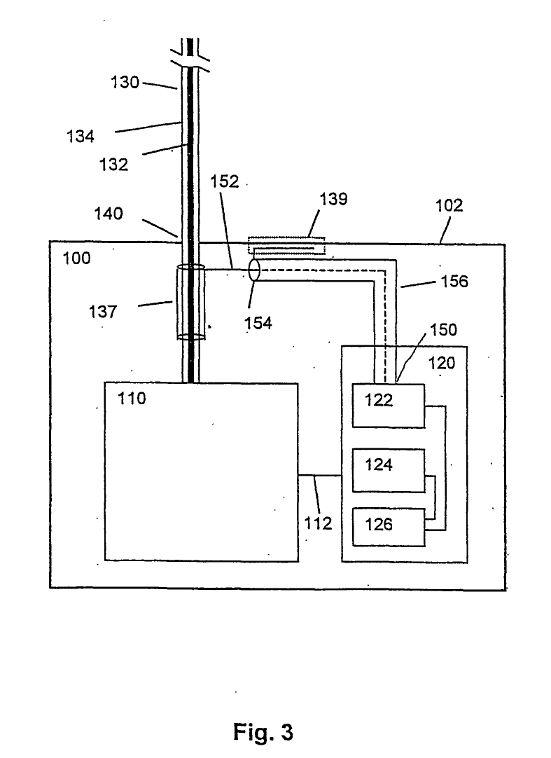

FIG. 3 illustrates system components in an installation cabinet in which is included an antenna device according to a second embodiment of the invention.

In this embodiment too, the antenna device comprises a signal connection of the antenna output 150 to a section of the supply line inside the installation cabinet 100. In this case, however, the signal connection is a capacitive coupling. This is achieved by the antenna device comprising a first capacitive coupling element 137 for capacitive connection of the first 152 conductor to the section of the supply line and a second capacitive coupling element 139 for capacitive connection of the second conductor 154 to the chassis potential of the installation cabinet 100.

The capacitive coupling elements may be implemented by means of metallic tape. The first capacitive coupling element may be a metallic tape that envelops the supply line, while the second capacitive coupling element may be a metallic tape arranged in against the wall of the cabinet 100.

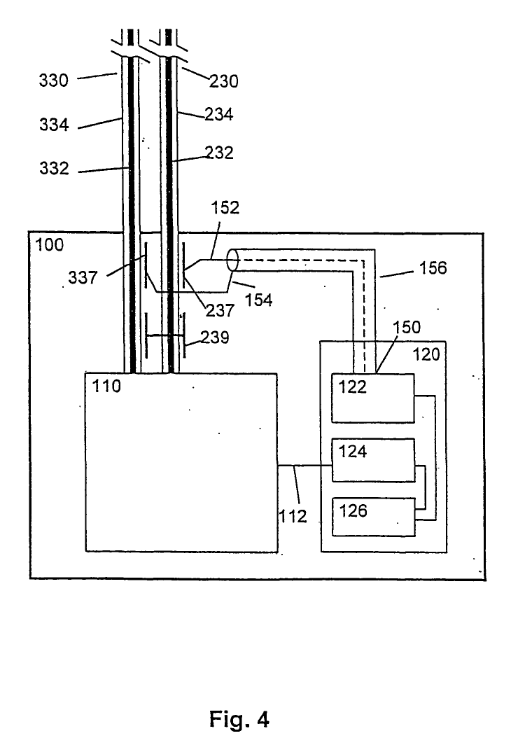

FIG. 4 illustrates system components in an installation cabinet in which is included an antenna device according to a third embodiment of the invention.

In this embodiment too, the antenna device comprises a signal connection of the antenna output 150 to a section of the supply line inside the installation cabinet 100.

In this case, however, at least a first 230 and a second 330 supply line are passed through openings in the installation cabinet. The signal connection is capacitive, as in the embodiment in FIG. 3. However, this is achieved here by the antenna device comprising
a first capacitive coupling element 237 for capacitive connection of the first conductor 152 to a section of the first supply line 230 inside the installation cabinet 100,
a second capacitive coupling element 337 for capacitive connection of the second conductor 154 to a section of the second supply line 330 inside the installation cabinet 100, and
a third capacitive coupling element 239 for capacitive connection of the first 230 and second 330 supply lines inside the installation cabinet 100. This third coupling element is designed so as to create an approximate short circuit for those frequencies employed by the transceiver circuit 120.

FIGS. 5a-5b illustrate two alternative detail solutions for matching to the frequency range 60 MHz-90 MHz.

FIG. 5a is a schematic circuit diagram illustrating matching of the antenna device for use in the frequency range 60 MHz-90 MHz. Here the antenna output 150 for the transceiver circuit 122 is connected to an impedance matching transformer 160. The transformer has two output terminals, where the first 161 is connected to the cabinet's 100 chassis. The transformer's second output terminal 162 is connected via a condenser 164 with a value typically of 100 pF to a point 165, which is connected to the supply line 130. FIG. 5a also illustrates a power supply circuit 170 for diverting from the supply lines a supply voltage to the transceiver circuit 122 inter alia. The power supply circuit 170 is connected to the supply network partly from the first supply line 130 at the point 165 via an inductor 167 with inductance typically of 10 μH, and partly from the second supply line via a direct connection 166.

FIG. 5b illustrates a solution identical to that in FIG. 5a, but in this case an additional inductor 168 is also depicted with inductance typically of 10 μH, inserted in series with the supply line 130 that is employed as antenna element.

The above embodiments should be regarded merely as examples. Those skilled in the art will understand that a number of alternative solutions will fall within the scope of the invention, as it is defined by the attached patent claims and their equivalents.

For example, the signal connection between the radio transmitter and the supply cable or supply cables may be performed inductively instead of galvanically or capacitively. This may be implemented by the supply line being wound around an iron or ferrite rod. A cable terminal as illustrated in FIG. 2 can easily be modified by ordinary skilled persons in order to adapt it to the capacitive or inductive form of connection. Even though the cable terminal is illustrated as arranged for connection to a single conductor, it will be a simple matter for a person skilled in the art to make the necessary adaptations to enable the cable terminal to be employed for two supply lines simultaneously. In this case supply voltage to the radio transmitter 122 and possibly to the remote reading device 120 can also be provided by means of the cable terminal.

1. An antenna device for use with a radio transmitter (122) mounted in an electrical installation cabinet (100) such as a fuse box, where at least one electrical supply line (130) is passed through an opening (140) in the installation cabinet (100), comprising a signal connection of the radio transmitter's antenna output (150) to a section of the supply line inside the installation cabinet (100), said radio transmitter's antenna output (150) comprising a first (152) and a second (154) conductor, the device further comprises connector devices for connecting the first conductor (152) to a first point (136; 137) on the supply line, characterised in
that the device further comprises connector devices for connecting the second conductor (154) to a second point (138) on the supply line,
whereby the supply line (130) is employed as a travelling wave antenna for the radio transmitter (122).

2. A device according to claim 1, where the signal connection is a galvanic connection, the device comprising contact devices for connecting the first conductor (152) to a first point (136) on the supply line and the second conductor (154) to a second point (138) on the supply line.

3. A device according to claim 2, designed as a cable terminal, arranged to enclose the supply line (130), where the contact devices comprise metallic contacts designed to be pressed through an insulation sheath (134) in order thereby to come into contact with the electrical conductor (132) in the supply line (130).

4. A device according to one of the claims 1-3, where the radio transmitter (122) is a combined radio transmitter and receiver operating on a frequency greater than or equal to 60 MHz.

5. A remote reading device (120) for remote reading of an energy consumption meter (110), to be mounted in an electrical installation cabinet (100) such as a fuse box, where at least one electrical supply line (130) is passed through ad opening in the installation cabinet (100), comprising
a reading unit (124) for reading the supply meter (110),
a control unit (126), and
a radio transmitter (122),
characterised in that it further comprises an antenna device for use with the radio transmitter, as indicated in claim 1, whereby the supply line (130) is employed as a travelling wave antenna for the radio transmitter (122).

6. A method for providing an antenna for a radio transmitter (122) with an antenna output (150) comprising a first (152) and a second (154) conductor, said transmitter (122) being mounted in an electrical installation cabinet (100) such as a fuse box, where at least one electrical supply line (130) is passed through an opening in the installation cabinet, said method comprising the step of
signal connection of the radio transmitter's antenna output (150) to a section of the supply line (130) inside the installation cabinet,
the method comprising a signal connection of the first conductor (152) to a first point (136; 137) on the supply line,
characterised in that the method further comprises
a signal connection of the second conductor (154)
to a second point (138) on the supply line,
whereby the supply line (130) is employed as a travelling wave antenna for the radio transmitter (122).

7. A method as indicated in claim 6, where the radio transmitter is a combined radio transmitter and receiver operating on a frequency greater than or equal to 60 MHz.

8. Use of a single electrical supply line, which is passed into or out of an electrical installation cabinet such as a fuse box, as a travelling wave antenna for a radio transmitter mounted inside the installation cabinet
